(19) United States
(12) Patent Application Publication
(10) Pub. No.: US 2002/0093506 A1
(43) Pub. Date: Jul. 18, 2002

(54) Apparatus and method for storing and retrieving images for transmission to an output device

(76) Inventor: Jay A. Hobson, Santa Clara, CA (US)

Correspondence Address: SUN MICROSYSTEMS INC, 901 SAN ANTONIO RD, MS PALO1-521, PALO ALTO, CA, 94303, US

(21) Appl. No.: 09/760,637

(22) Filed: Jan. 16, 2001

(51) Int. Cl. G09G 5/36

(52) U.S. Cl. 345/553; 345/557; 345/564; 345/556

(57) ABSTRACT

Apparatus and methods for storing and retrieving images for transmission to an output device are disclosed. A cache comprising one or more bitmaps is examined to determine whether the image to be transmitted generates a match with a bitmap already stored on the cache. If a match is found, the bitmap matching the image to be transmitted is retrieved from the cache. If no match is found, a bitmap representing the image is stored in the cache.

### BACKGROUND OF THE INVENTION

1. Field of the Invention

The present invention relates generally to the retrieval of images for display on an output device, and in particular, the rendering of fonts on an output device, and more particularly, to the caching of bitmaps in a font independent manner during the rendering of fonts on an output device.

2. Description of Related Art

The use of images in computer-generated files and documents has long been an important feature in many aspects of computing, including such uses as desktop publishing and other applications software development, and the publication of documents on the Internet via the World Wide Web.

Images in computer-generated documents are used not only in and of themselves, as photographs or diagrams, but also as an accompaniment to text. Files and documents that are accessible via the World Wide Web using a conventional browser program, for example, often include a combination of text and images. Images used in combination with text may include larger graphics such as photographic images, diagrams, graphs, or banners, which may be displayed in conjunction with text. However, images used in combination with text may also include smaller graphics, such as graphical icons that are placed inline with text.

In a computer-generated document, the text itself may comprise images. For example, many application software programs today permit a user to select from a wide array of fonts in which to display user-entered text. Some well-known fonts may include, for example, Helvetica, Courier, Times New Roman, and Arial. The user may also, in turn, select from a wide variety of font style and font sizes in which to display the user's chosen font.

One result of all these available choices for creating documents is that data for image generation often comprise a large proportion of the data in the file of a computer-generated document. In addition, file sizes for images are generally large, as images must be defined at a sufficient resolution or level of detail in order to support the continuous nature of many images, particularly when viewed by the human eye. Furthermore, when a font is selected for use in displaying text in a document, the entire font may be generated, and all of the characters in the font stored with the document, and may contribute to the large file sizes.

The rapidly occurring improvements in computing technology, such as faster, more powerful processors, higher resolution printers, and the wide availability of inexpensive computer memory, ensure that image file sizes are likely to remain large or may even get larger. However, even with the rapid improvements in computing and networking technology, transmission of files containing images, e.g. from one computer to another computer or to a storage device, or from a computer to a printer, is often limited by the bandwidth of the various interconnections between systems. This limited bandwidth can often be a bottleneck to efficient file transfer.

Thus, one challenge for operating system and application software developers has been to find ways to improve the efficiency of output file transfer and storage. One method of improving these efficiencies is to reduce the size of files containing images. One way to reduce file size is to exploit the fact that in documents containing text displayed using fonts, often only a few characters in a particular font set is used. One technique for reducing the amount of font data in documents is known as font subsetting. This technique is to create a font and include in it only those characters that appear in the text of the document. For example, a Japanese font set may contain several thousand characters and may be oriented to print text in horizontal rows. If only several hundred different characters are actually used in the document, only the characters used in a document will be created and stored using the font subset method, thus saving a great deal of time and storage space as compared with generating and storing the entire font.

However, the font subsetting technique discussed above may lack flexibility in certain applications. Font subsetting also involves high overhead for each font selected. In particular, in font subsetting, for each font used in an output file, the font must be located on the computer system, where it is usually stored on a memory or other storage medium as a font file. The font in the font file must be uncompressed and decrypted, and the characters included in the output file must be identified and parsed. Including the font in the output file using a font subset typically requires defining a header, creating and defining the font, generating drawing functions for drawing characters, and including the subset of characters used in the file. The font subset may also need to be compressed and encrypted as a font file. Thus, for output files where many different fonts are used, there is potentially a great deal of processing and data storage overhead associated with the font subsetting technique.

Furthermore, font subsetting recognizes only duplication of characters defined within a font set, and does not recognize duplication of characters between font sets, or duplication of other images. For example, a document may contain Japanese characters, some of which may be defined using a Japanese font set oriented to print characters in horizontal rows. In addition, some characters may be defined using a Japanese font set oriented to print characters in vertical rows. Many of the Japanese characters used in these two font sets are the same, as generally only the Roman characters within the sets are rotated. Using the font subset method, two fonts would be built that contained instances of the particular characters printed while that font was in use. If the same character were used in each font, then two instances of the exact same bitmap would be included in the output file generated. To use this technique, a new font subset must be created for each font used in the document.

These and other known techniques do not provide a flexible, easy to implement method of storing images such that a particular image is stored only once, regardless of the font sets with which it is associated, or whether it is indeed associated with any font set.

### SUMMARY OF THE INVENTION

A method and apparatus in one embodiment of the present invention reduce output file size and improve efficiency of file transmission to an output device. In one embodiment, the method of retrieving images for display on an output device includes:

retrieving a bitmap from the cache when the bitmap generates a match with an image selected for display on said output device; and

storing in the cache a bitmap representing the selected image, if the selected image does not generate a match with any bitmap stored on the cache.

According to one embodiment of the invention, the method may further comprise assigning a unique identifier to a bitmap stored in the cache, and this unique identifier may be employed each time an image corresponding to the bitmap is included in an output file.

According to one embodiment of the invention, the method may also comprise including the unique identifier of a bitmap stored in the cache in a file sent to an output device. Thus, an image that appears multiple times in an output stream may be stored only once using the cache. The unique identifier may be employed to retrieve from the cache the bitmap corresponding to the image.

According to one embodiment of the invention, the method may further comprise retrieving from the cache the bitmap corresponding to the unique identifier in response to a request to display the file on the output device.

In one embodiment of the invention, the image selected for display comprises a character associated with a font set. In another embodiment of the invention, the image selected for display is arbitrary and need not comprise a character associated with a font set.

A further implementation of the present invention provides a computer program product comprising computer program code for a method for retrieving images for display on an output device. The method includes program code adapted for retrieving a bitmap from a cache when the bitmap generates a match with an image selected for display on said output device; and for storing in the cache a bitmap representing the selected image if the selected image does not generate a match with any bitmap stored in the cache.

According to one embodiment of the invention, the program code may be embodied in any form of a computer program product. A computer program product includes a medium which stores or transports computer readable program code, or in which computer readable code may be embedded. Some examples of computer program products are: CD-ROM discs, ROM cards; floppy discs; magnetic tapes; computer hard drives; servers on a network; and signals transmitted over a network representing a computer readable program code.

According to another embodiment of the invention, the computer readable program code may employ any programming language. In one embodiment, the programming language comprises a high level programming language, such as C, which can be read by the computer using compiling and linking methods known in the art.

Another embodiment of the present invention provides a processor; and a memory coupled to said processor, and storing a method of retrieving images for display on an output device. Upon execution of said method on said processor, the method comprises retrieving from a cache a bitmap, wherein the bitmap matches an image selected for display on said output device; and storing in the cache a bitmap representing the selected image, if the selected image does not match with any bitmap stored on the cache.

A further embodiment of the present invention provides an output file format comprising a cache section including at least one bitmap associated with a unique identifier; and a data section including a plurality of occurrences of at least one unique identifier associated with the at least one bitmap in the cache section. Each occurrence of a unique identifier is associated with a specified position, and for each occurrence of a unique identifier in the data section, an image represented by the bitmap associated with the unique identifier is displayed on an output device in the specified position.

One advantage of the present invention is that the size of files created for transmission to an output device may be reduced through the use of the cache, as a bitmap representing an image to be displayed is written to the file only one time.

Another advantage of the present invention is that since each bitmap is thus transmitted to the output device only one time, slow transmission and storage access times are reduced for files that utilize particular images repeatedly (such as an image of a particular character in a font set).

A further advantage of the present invention is that a particular bitmap representing a particular image is stored in the cache only one time, independent of any defined attributes associated with the bitmap, such as font, style, or other category.

These and other features and advantages of the present invention will be more readily apparent from the detailed description set forth below taken in conjunction with the accompanying drawings.

### BRIEF DESCRIPTION OF THE DRAWINGS

FIG. 1 shows a block diagram of a computer system, which is used in connection with an embodiment of the present invention.

FIG. 2 shows a flowchart of a method used in connection with an embodiment of the present invention.

FIG. 3 shows a flowchart of another method used in connection with an embodiment of the present invention.

FIG. 4 shows a flowchart of yet another method used in connection with an embodiment of the present invention.

FIG. 5 shows an implementation of a cache used in an embodiment of the present invention.

FIG. 6 shows an output file used in connection with an embodiment of the present invention.

In the drawings and the following detailed description, elements with the same reference numeral are the same element. Also, the first digit of a reference numeral for an element indicates the first drawing in which that element appeared.

### DETAILED DESCRIPTION

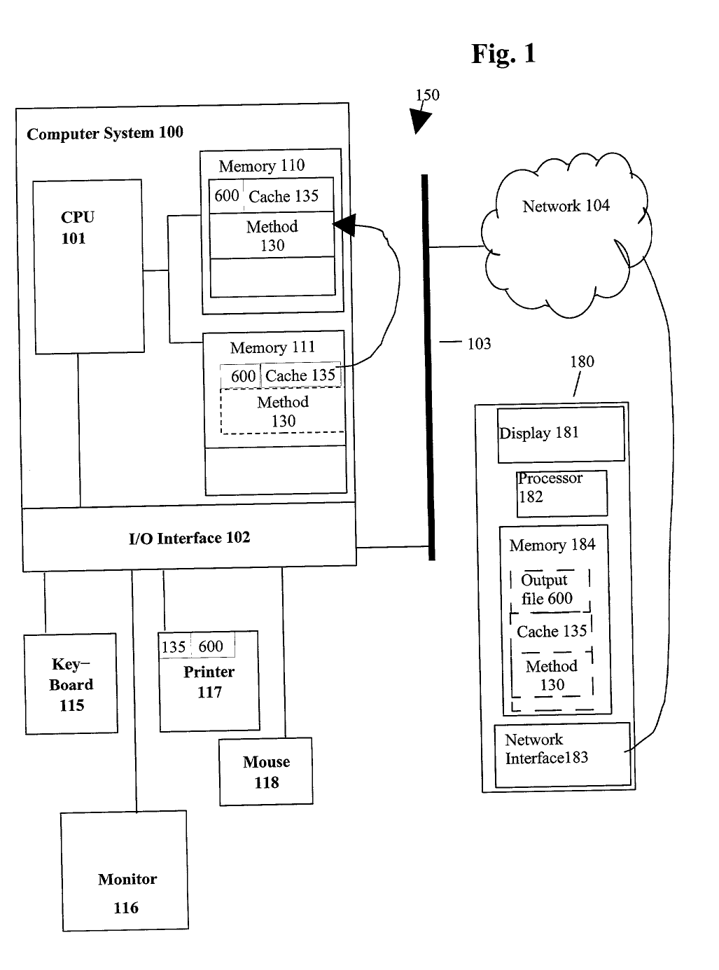

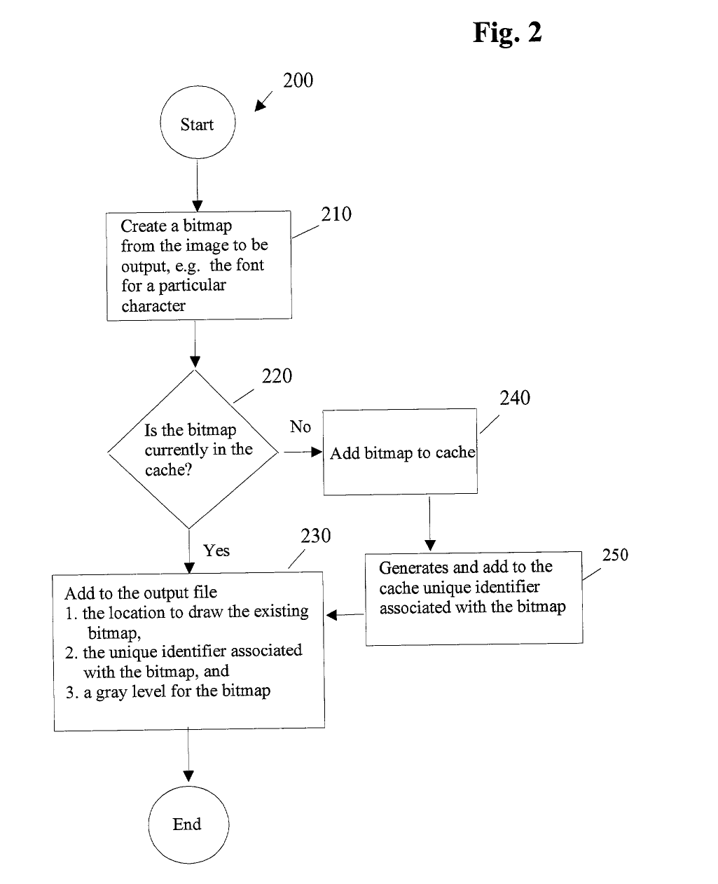

A method 130 (FIG. 1) in an embodiment of the present invention, provides the functionality for storing and retrieving images in order to provide more efficient transmission of output files to an output device, such as printer 117, and more efficient storage of output files in a storage medium, such as memory 110 or 111. In an embodiment of the inventive method illustrated at 200 in FIG. 2, a cache 135 comprising one or more bitmaps is created and stored with an output file. Bitmaps are created from images to be transmitted to the output device at create bitmap operation 210. When an image is to be transmitted to the output device in method 200, the cache is examined at search cache operation 220 to determine whether the image to be transmitted generates a match with a bitmap already stored on the cache. If a match is found, at output file addition operation 230, the unique identifier of the bitmap matching the image to be transmitted is retrieved from the cache 135 and written to the output file, along with a location to draw the existing bitmap. In the embodiment of the present invention shown in FIG. 2, a gray level specifying the intensity of the bitmapped image written to the output file may be defined. Note, however, that the intensity of the image may be specified without defining a gray level; for example, the intensity may be defined within the bitmap itself, or by the output device displaying the image.

If no match is found, an embodiment of the method of the present invention proceeds to add bitmap to cache operation 240, where a bitmap representing the image is stored in the cache 135. In add unique identifier operation 250, a unique identifier is stored in association with the bitmap in cache 135. The embodiment of the method shown in FIG. 2 then proceeds to output file addition operation 230, where the unique identifier of the newly cached bitmap is written to the output file.

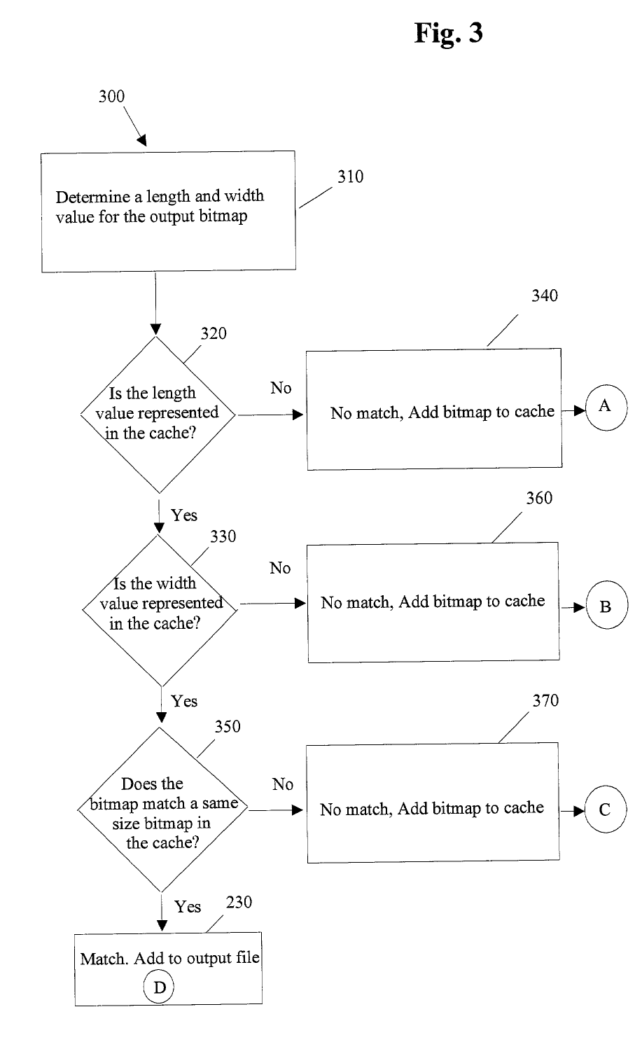

FIG. 3 describes an embodiment 300 of a method of the present invention for determining whether a bitmap generated for an output file matches a bitmap currently stored in the cache. First, in determine dimensions operation 310, the dimensions of the output bitmap are determined. The dimensions of the output bitmap are then compared to the dimensions of bitmaps currently stored in the cache, in order to identify a subset of potential matching bitmaps within the cache, wherein each bitmap in the subset has the same dimensions as the output bitmap. In one embodiment of the present invention, the output bitmap comprises a two-dimensional array of bits, and thus the dimensions of the output bitmap comprise two values, a length value and a width value. Note, however, that bitmaps of more than two dimensions may potentially be employed in embodiments of the present invention.

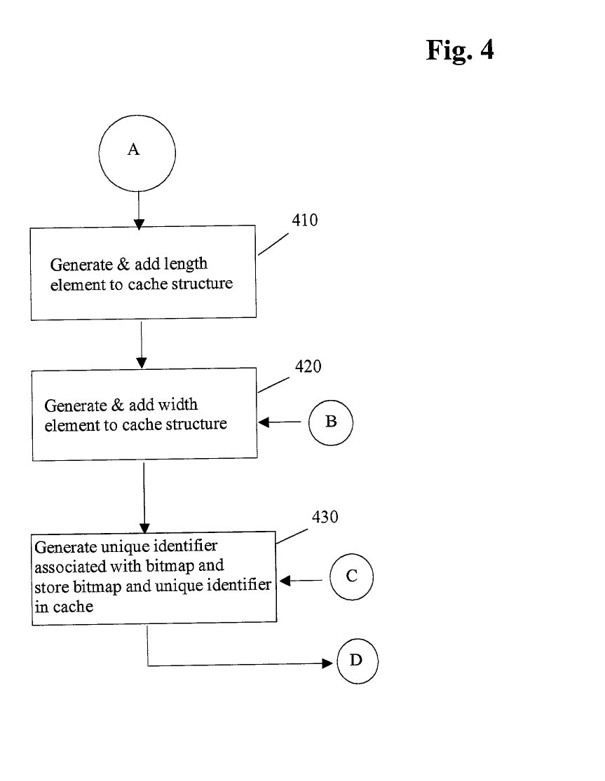

In length value check operation 320, it is determined whether the length value of the output bitmap is represented in the cache. If the length value is represented in the cache, then it is determined whether the width value of the output bitmap is represented in the cache at width value check operation 330. If the length value of the output bitmap is not represented in the cache, then the output bitmap does not match any bitmap in the cache and the output bitmap must be added to the cache at add bitmap to cache operation 340. This operation continues at generate length element operation 410 on FIG. 4.

FIG. 4 illustrates an embodiment of a method to perform add bitmap to cache operation 340 used in the present invention. In generate length element operation 410, an index comprising the length value of the output bitmap is added to the cache. Generate width element operation 420 adds to the cache an index comprising the width value of the output bitmap. Once indices comprising the length and width values of the output bitmap are in the cache, then the output bitmap, along with a unique identifier generated for the output bitmap, may be stored in the cache for future reference at store output bitmap and unique identifier operation 430.

At width value check operation 330 in FIG. 3, if the width value of the output bitmap is represented in the cache, then each bitmap having width and length values matching the output bitmap is examined to determine if it matches the output bitmap in bitmap match check operation 350.

If the width value of the output bitmap is not represented in the cache, then the output bitmap is added to the cache at add bitmap to cache operation 360. A width value element is created and included in the cache at generate width index operation 420. The output bitmap is then added to the cache at store output bitmap and unique identifier operation 430.

In an embodiment of the present invention, bitmap match check operation 350 is performed on an individual cached bitmap to determine if each bit in the cached bitmap matches the corresponding bit in the output bitmap. Embodiments of the present invention may employ the functionality of a string compare function such as that found in the C programming language to perform this check.

If no match is identified, then the output bitmap is added to the cache at add bitmap to cache operation 370. The output bitmap is added to the cache, indexed by the length element and width element matching the output bitmaps dimensions at store output bitmap and unique identifier operation 430. However, if a match is identified at check operation 350, then the unique identifier associated with the matching cached bitmap is retrieved at add unique identifier to output file operation 230.

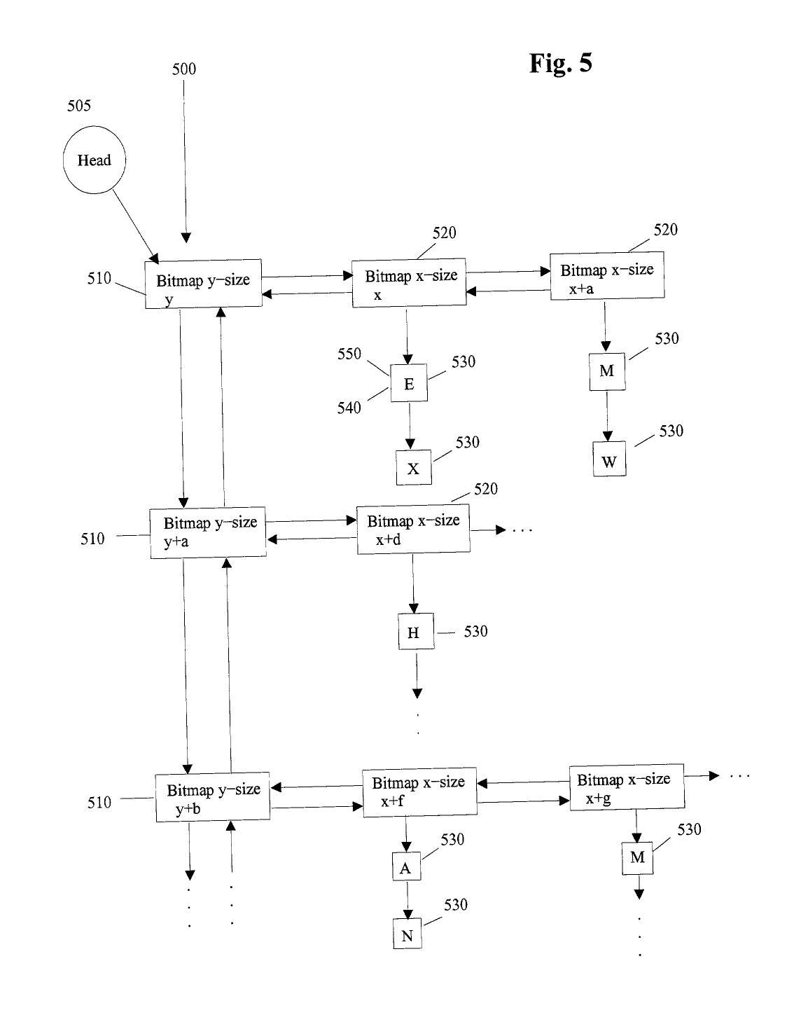

Embodiments of the present invention may utilize any of a variety of data structures known in the art to implement the cache, such as arrays, linked lists, queues, hash tables, or the like. In one embodiment of the present invention shown in FIG. 5, a cache is implemented as a doubly linked list 500 of length elements 510, wherein the length elements 510 may be arranged in a predetermined order for efficient searching, such as an increasing order. Each length element 510 of the list in turn comprises a doubly linked list of width elements 520, wherein the width elements 520 may also be arranged in a predetermined order, such as an increasing order, for efficient searching. Each width element 520 in turn includes a pointer to a list of bitmap elements 530, wherein each bitmap element comprises a bitmap 540 and an associated unique identifier 550. A head 505 of list 500 may be established, where the head 505 points to the smallest length element value 510. In one embodiment of the present invention, searches of the cache may be initiated at head 505. The implementation of the cache as a doubly linked list permits efficient search of the cache for a matching bitmap, as well as efficient insertion and deletion of length and width elements using routines well known in the art.

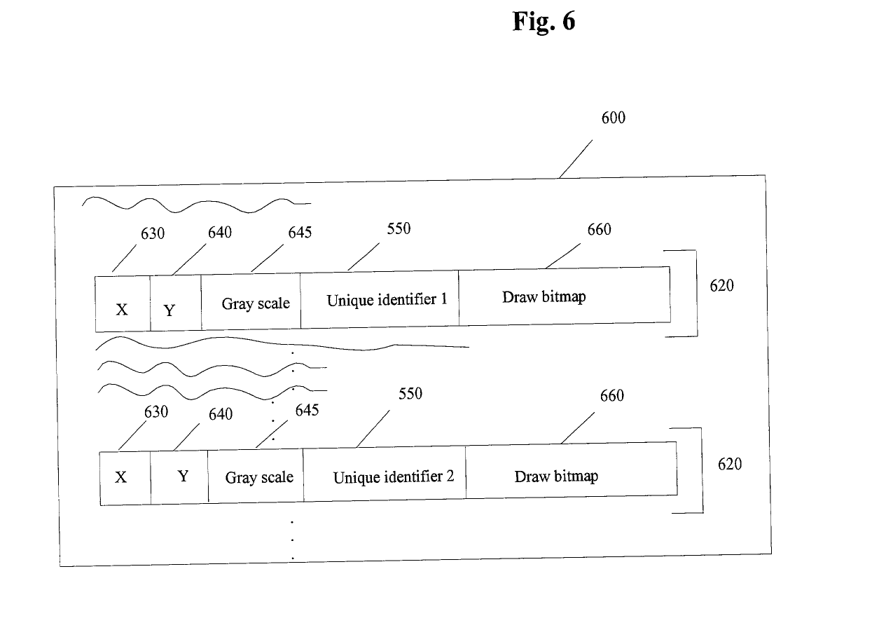

In one embodiment of the present invention, cache 135 may be stored and transmitted in association with an output file 600, shown in FIG. 6. An output file 600 comprises one or more operations for displaying or printing graphics and text on an output device such as printer 117 or monitor 116. In one embodiment of the present invention, the operations comprising the output file 600 may be expressed in a programming language known in the art. In embodiments of the present invention, operations of output file 600 are expressed using a page description language, such as PostScript, which may be interpreted and executed in a uniform manner on a wide array of output devices. According to embodiments of the present invention, output file 600 includes one or more image entries 620 for display of an image. Image entry 620 includes a unique identifier 550 associated with a bitmap stored in the cache, as well as x- and y-coordinates 630 and 640 specifying a position on the display space on which to display the bitmapped image, and one or more bitmap drawing functions 660. In one embodiment of the present invention, a gray scale value 645 may also be included in the image entry to define the intensity level of the image. When the output file 600 is read by the output device, a bitmapped image corresponding to unique identifier 550 is retrieved from the cache, and is displayed upon execution of the specified drawing functions at the specified location.

In one embodiment of the present invention, an image may comprise a character generated using a predefined font set. However, the images stored in the cache need not correspond to characters associated with font sets, and can comprise arbitrary non-character images, or a combination of character and non-character images.

Those skilled in the art will readily recognize that the individual operations mentioned before in connection with the procedure of retrieving images for display according to method 130 of the present invention (and other operations and functions mentioned in connection with the foregoing description of the invention) can be performed by executing computer program instructions on CPU 101 of computer 100. The invention, however, may also be implemented by dedicated electronic circuits, which are configured such that they perform the individual operations explained before in connection with method 130 of the present invention. The invention may also be implemented by a storage medium having thereon installed computer-executable program code, which causes the CPU of a computer to perform the operations explained above according to the present invention.

The present invention is applicable to a hardware configuration like a personal computer or workstation as illustrated schematically in FIG. 1 by computer system 100. The invention, however, may also be applied to a client-server configuration that also is illustrated in FIG. 1. The images may be outputted, e.g. to printer 117 for printing, or displayed on a display screen 116 of client device 100 while some or all operations of method 130 are carried out on a server computer 180 accessible by client device 100 over a data network 104, such as the Internet, using a browser application or the like.

Herein, a computer program product comprises a medium configured to store or transport computer readable code for method 130 or in which computer readable code for method 130 is stored. Some examples of computer program products are CD-ROM discs, ROM cards, floppy discs, magnetic tapes, computer hard drives, servers on a network and signals transmitted over a network representing computer readable program code.

As illustrated in FIG. 1, this storage medium may belong to computer system 100 itself. However, the storage medium also may be removed from computer system 100. For example, method 130 and cache 135 may be stored in memory 184 that is physically located in a location different from processor 101. Cache 135 may be stored separately from method 130. In one embodiment, cache 135 comprises a portion of an output file, such as a PostScript file, that is transmitted to an output device, such as a printer. (PostScript is a registered trademark of Adobe Systems, Inc.) The only requirement is that processor 101 is coupled to the memory containing method 130 and cache 135. This could be accomplished in a client-server system 150, e.g. system 100 is the client and system 180 is the server, or alternatively via a connection to another computer via modems and analog lines, or digital interfaces and a digital carrier line.

For example, memory 184 could be in a World Wide Web portal, while display unit 116 and processor 101 are in personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130, or at least can provide the input instructions to method 130 that is executed on another system. Similarly, in another embodiment, computer system 100 can be comprised of multiple different computers, wireless devices, cellular telephones, digital telephones, two-way pagers, or personal digital assistants, server computers, or any desired combination of these devices that are interconnected to perform, method 130 as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 130 can be implemented in a wide variety of computer system configurations. In addition, method 130 could be stored as different modules in memories of different devices. For example, method 130 could initially be stored in a server computer 180, and then as necessary, a module of method 130 could be transferred to a client device 100 and executed on client device 100. Consequently, part of method 130 would be executed on the server processor 182, and another part of method 130 would be executed on processor 101 of client device 100. In view of this disclosure, those of skill in the art can implement the invention of a wide-variety of physical hardware configurations using an operating system and computer programming language of interest to the user. For example, FIG. 1 shows input devices 116 and 118, but other input devices, such as speech recognition software and/or hardware could be used to input the selections and data for method 130.

In yet another embodiment, method 130 is stored in memory 184 of system 180. Stored method 130 is transferred, over network 104 to memory 111 in system 100. In this embodiment, network interface 187 and I/O interface 102 would include analog modems, digital modems, or a network interface card. If modems are used, network 104 includes a communications network, and method 130 is downloaded via the communications network.

Method 130 of the present invention may be implemented in a computer program including a comprehensive SOLARIS operating system that is available from Sun Microsystems, Inc. of Palo Alto, Calif. (SOLARIS is a trademark of Sun Microsystems.) Such a computer program may be stored on any common data carrier like, for example, a floppy disk or a compact disc (CD), as well as on any common computer system's storage facilities like hard disks. Therefore, the present invention also relates to a data carrier for storing a computer program for carrying out the inventive method. The present invention also relates to a method for using a computer system for carrying out the presented inventive method. The present invention further relates to a computer system with a storage medium on which a computer program for carrying out the presented inventive method is stored.

While the present invention hereinbefore has been explained in connection with one embodiment thereof, those skilled in the art will readily recognize that modifications can be made to this embodiment without departing from the spirit and scope of the present invention.

I claim:

1. A method for retrieving images for display on an output device, said method comprising:
retrieving a bitmap from a cache, when the bitmap generates a match with an image selected for display on said output device; and
storing in the cache a bitmap representing the selected image, if the selected image does not generate a match with any bitmap stored on the cache.

2. The method of claim 1, wherein:
the image selected for display comprises a character associated with a font set.

3. The method of claim 1, wherein said storing further comprises:
assigning a unique identifier to a bitmap stored in the cache.

4. The method of claim 3, wherein said method further comprises:
including the unique identifier of a bitmap stored in the cache in a file sent to an output device.

5. The method of claim 4 wherein said method further comprises:
retrieving from the cache the bitmap corresponding to the unique identifier in response to a request to display said file on said output device.

6. The method of claim 1 wherein:
the cache comprises a linked list data structure having length elements.

7. The method of claim 6, wherein
a length element of the linked list data structure is associated with a unique length value and the elements of the linked list data structure are organized in order of increasing length values.

8. The method of claim 6 wherein storing a bitmap in the cache further comprises:
associating the bitmap with the length element of the linked list data structure corresponding to a length value of the bitmap.

9. The method of claim 8, wherein associating the bitmap with the length element corresponding to the length value of the bitmap further comprises:
associating the bitmap with a width element corresponding to a width value of the bitmap, wherein the width element is associated with the length element corresponding to the length value of the bitmap.

10. The method of claim 1, wherein
the output device comprises a printer.

11. A computer program product comprising computer program code for a method for retrieving images for display on an output device, said method comprising:
retrieving a bitmap from a cache, when the bitmap generates a match with an image selected for display on said output device; and
storing in the cache a bitmap representing the selected image if the selected image does not generate a match with any bitmap stored in the cache.

12. The computer program product of claim 11, wherein
the image selected for display comprises a character associated with a font set.

13. The computer program product of claim 11, wherein said storing further comprises:
assigning a unique identifier to a bitmap stored in the cache.

14. The computer program product of claim 13, wherein said method further comprises:
including the unique identifier of a bitmap stored in the cache in a file sent to an output device.

15. The computer program product of claim 14, wherein said method further comprises:
retrieving from the cache the bitmap corresponding to the unique identifier in response to a request to display said file on said output device.

16. The computer program product of claim 11, wherein:
the cache comprises a linked list data structure having length elements.

17. The computer program product of claim 16, wherein:
a length element of the linked list data structure is associated with a unique length value and the elements of the linked list data structure are organized in order of increasing length values.

18. The computer program product of claim 17 wherein said storing a bitmap in the cache further comprises:
associating the bitmap with the length element of the linked list data structure corresponding to a length value of the bitmap.

19. The computer program product of claim 11, wherein said associating the bitmap with the length element corresponding to the length value of the bitmap further comprises:
associating the bitmap with a width element corresponding to a width value of the bitmap, wherein the width element is associated with the length element corresponding to the length value of the bitmap.

20. The computer program product of claim 11, wherein
the output device comprises a printer.

21. An apparatus comprising:
a processor; and
a memory coupled to said processor, and storing a method of retrieving images for display on an output device wherein upon execution of said method on said processor, said method comprises:
retrieving a bitmap from a cache, wherein the bitmap generates a match with an image selected for display on said output device; and
storing in the cache a bitmap representing the selected image, if the selected image does not match with any bitmap stored on the cache.

22. The apparatus of claim 21, wherein:
the image selected for display comprises a character associated with a font set.

23. An output file format, comprising:
a cache section including at least one bitmap associated with a unique identifier; and
a data section including a plurality of occurrences of at least one unique identifier associated with the at least one bitmap in the cache section, wherein each occurrence of a unique identifier is associated with a specified position, and for each occurrence of a unique identifier in the data section, an image represented by the bitmap associated with the unique identifier is displayed on an output device in the specified position.
